(19) United States
(12) Patent Application Publication
(10) Pub. No.: US 2012/0093548 A1
(43) Pub. Date: Apr. 19, 2012

(54) FIXING DEVICE AND IMAGE FORMING APPARATUS

(76) Inventor: Taku KIMURA, Tokyo (JP)

(21) Appl. No.: 13/238,520

(22) Filed: Sep. 21, 2011

(30) Foreign Application Priority Data
Oct. 14, 2010 (JP) 2010-231654

(51) Int. Cl. G03G 15/20

(52) U.S. Cl. 399/329

(57) ABSTRACT

A fixing device includes a fixing belt with an endless shape to be heated with a heating member; a pressing roller disposed outside the fixing belt; a fixing side roller disposed inside the fixing belt and pressed against the pressing roller with the fixing belt in between; and a nip forming member disposed inside the fixing belt and pressed against the pressing roller with the fixing belt in between. Further, the fixing side roller is arranged to form a strain portion having a strain amount in the pressing roller so that the strain amount is greater than a strain amount of a strain portion formed in the pressing roller with the nip forming member.

### BACKGROUND OF THE INVENTION AND RELATED ART STATEMENT

The present invention relates to a fixing device including a belt and an image forming apparatus including the fixing device.

A conventional image forming apparatus such as a copier, a printer, a facsimile, and the like is capable of forming a monochrome image or a color image. In the conventional image forming apparatus, a fixing device uses a belt as a fixing member. In the fixing device, a fixing side roller and a nip forming member such as a fixing pad are disposed to contact with an inner surface of the belt. Further, a pressing roller is arranged to face the fixing side roller and the nip forming member with the belt in between. Accordingly, the fixing side roller, the nip forming member and the pressing roller are arranged to form a nip portion for pressing a transported recording medium against the belt (Refer to Patent Reference).

Patent Reference: Japanese Patent Publication No. 2005-242111

In the fixing device described above, when the fixing side roller, the nip forming member and the pressing roller are arranged to sandwich the belt, it is difficult to form an image with high quality.

In view of the problems described above, an object of the present invention is to provide a fixing device and an image forming apparatus capable of forming an image with high quality.

Further objects and advantages of the invention will be apparent from the following description of the invention.

### SUMMARY OF THE INVENTION

In order to attain the objects described above, according to an aspect of the present invention, a fixing device includes a fixing belt with an endless shape to be heated with a heating member; a pressing roller disposed outside the fixing belt; a fixing side roller disposed inside the fixing belt and pressed against the pressing roller with the fixing belt in between; and a nip forming member disposed inside the fixing belt and pressed against the pressing roller with the fixing belt in between.

Further, in the aspect of the present invention, the fixing side roller is arranged to form a strain portion having a strain amount in the pressing roller so that the strain amount is greater than a strain amount of a strain portion formed in the pressing roller with the nip forming member.

In the aspect of the present invention, it is possible to form an image with high quality.

### BRIEF DESCRIPTION OF THE DRAWINGS

FIG. 1 is a schematic sectional view showing a configuration of a fixing device according to a first embodiment of the present invention;

FIGS. 2(a) and 2(b) are schematic sectional views showing a configuration of an image forming apparatus according to the first embodiment of the present invention, wherein FIG. 2(a) is a schematic sectional view showing the configuration of the image forming apparatus having the fixing device, and FIG. 2(b) is an enlarged schematic sectional view showing a developing device of the image forming apparatus;

FIGS. 3(a) and 3(b) are schematic sectional views showing a configuration of a fixing side roller or a pressing roller of the fixing device according to the first embodiment of the present invention, wherein FIG. 3(a) is a schematic sectional view showing one configuration the fixing side roller or the pressing roller of the fixing device, and FIG. 3(b) is a schematic sectional view showing another configuration of the pressing roller of the fixing device;

FIGS. 4(a) and 4(b) are schematic sectional views showing a configuration of a fixing belt of the fixing device according to the first embodiment of the present invention, wherein FIG. 4(a) is a schematic sectional view showing one configuration the fixing belt of the fixing device, and FIG. 4(b) is a schematic sectional view showing another configuration the fixing belt of the fixing device;

FIG. 5 is an exploded perspective view showing a plate shape heating member of the fixing device according to the first embodiment of the present invention;

FIG. 6 is a plan view showing the plate shape heating member of the fixing device according to the first embodiment of the present invention;

FIGS. 7(a) and 7(b) are perspective view showing the plate shape heating member and a supporting member of the fixing device according to the first embodiment of the present invention, wherein FIG. 7(a) is an exploded perspective view showing the plate shape heating member and the supporting member in a state before being assembled, and FIG. 7(b) is a perspective view showing the plate shape heating member and the supporting member in a state after being assembled;

FIGS. 8(a) and 8(b) are schematic side view showing a nip forming member of the fixing device according to the first embodiment of the present invention, wherein FIG. 8(a) is a schematic side view showing the nip forming member in a state before the nip forming member is attached to a supporting portion, and FIG. 8(b) is a schematic side view showing the nip forming member in a state after the nip forming member is attached to the supporting portion;

FIG. 9 is a schematic perspective view showing a modified example of the nip forming member of the fixing device according to the first embodiment of the present invention;

FIGS. 10(a) and 10(b) are schematic sectional views showing the pressing roller of the fixing device according to the first embodiment of the present invention, wherein FIG. 10(a) is a schematic sectional view showing the pressing roller with residual strain portions, and FIG. 10(b) is an enlarged schematic sectional view showing the pressing roller with the residual strain portions;

FIG. 11 is a schematic sectional view showing a modified configuration No. 1 of the fixing device according to the first embodiment of the present invention; and

FIG. 12 is a schematic sectional view showing a modified configuration No. 2 of the fixing device according to the first embodiment of the present invention.

### DETAILED DESCRIPTION OF PREFERRED EMBODIMENTS

Hereunder, embodiments of the present invention will be explained with reference to the accompanying drawings.

### First Embodiment

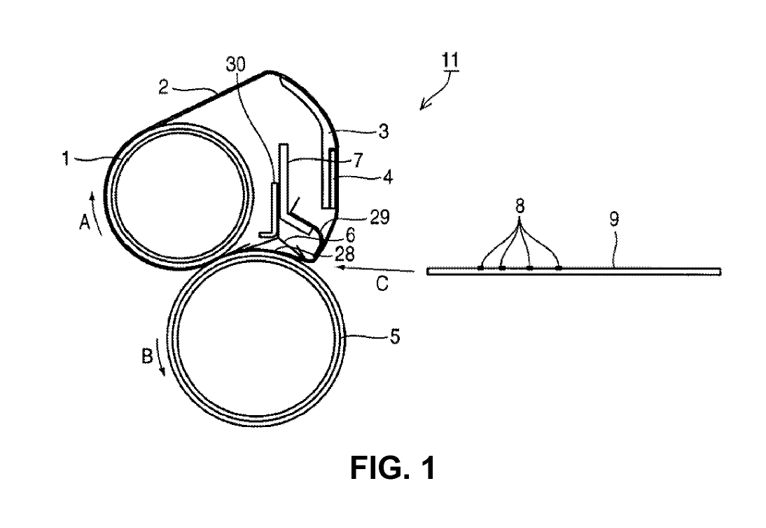

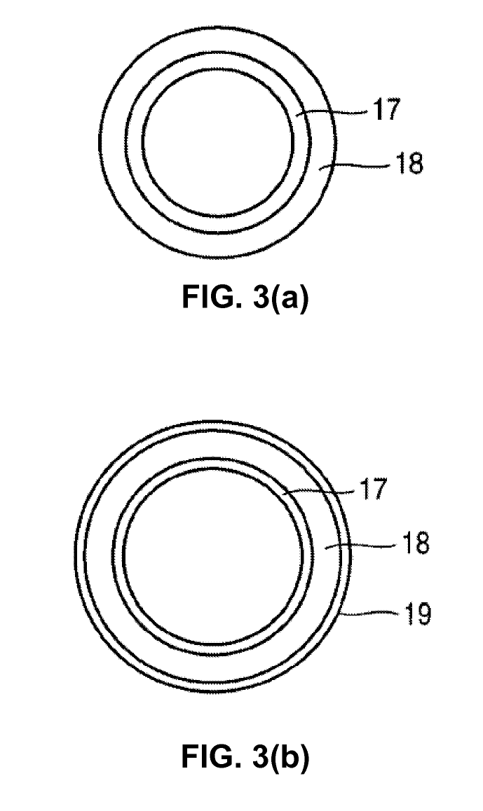

A first embodiment of the present invention will be explained. FIG. 1 is a schematic sectional view showing a configuration of a fixing device 11 according to the first embodiment of the present invention. FIGS. 3(a) and 3(b) are schematic sectional views showing a configuration of a fixing side roller 1 or a pressing roller 5 of the fixing device 11 according to the first embodiment of the present invention. More specifically, FIG. 3(a) is a schematic sectional view showing one configuration the fixing side roller 1 or the pressing roller 5 of the fixing device 11, and FIG. 3(b) is a schematic sectional view showing another configuration of the pressing roller 5 of the fixing device 11.

As shown in FIG. 1, the fixing device 11 includes the fixing side roller 1; a fixing belt 2; a supporting member 3; a plate shape heating member 4; the pressing roller 5; a nip forming member 6; and a supporting portion 7. The fixing device 11 is provided for fixing toner 8 transferred on a recording medium 9 through heating and pressing to the recording medium 9.

In the embodiment, the fixing belt 2 is a belt formed in an endless shape, and is extended with the fixing side roller 1, the nip forming member 6, and the supporting member 3 supporting the plate shape heating member 4. When the fixing side roller 1 rotates in an arrow direction A, the fixing belt 2 moves in the arrow direction A. It is noted that the fixing side roller 1 and the nip forming member 6 are disposed on an inside of the fixing belt 2. The plate shape heating member 4 as a heating member is disposed to press against an inner surface of the fixing belt 2 together with the supporting member 3, so that the plate shape heating member 4 heats the fixing belt 2. In this case, the supporting member 3 is arranged to press against the fixing belt 2 with a pressing force at most 2 kg·f, so that the fixing belt 2 smoothly slides against the supporting member 3.

In the embodiment, the pressing roller 5 is disposed on an outside of the fixing belt 2. Further, the pressing roller 5 is arranged to press against the fixing side roller 1 with a rotational shaft supported on a supporting member (not shown) and the nip forming member 6 supported on the supporting portion 7 with the fixing belt 2 in between. Accordingly, the pressing roller 5 is arranged to form a region contacting with the fixing side roller 1 and the nip forming member 6 through the fixing belt 2 (referred to as a nip region). It is noted that the fixing side roller 1 is disposed on a downstream side of the nip forming member 6 in a moving direction of the fixing belt 2. Further, the fixing side roller 1 and the nip forming member 6 are pressed against the pressing roller 5 with a specific pressing force through the fixing belt 2. The pressing roller 5 is pressed against the fixing side roller 1 to form a nip portion. A configuration of the nip forming member 6 will be described later.

In the embodiment, a temperature detection unit (not shown) such as a temperature sensor and the like is disposed near an outlet of the nip portion in the moving direction of the fixing belt 2. The temperature detection unit (not shown) is provided for detecting a temperature of the fixing belt 2 heated with the plate shape heating member 4. Further, the temperature detection unit (not shown) is disposed in a non-contact fashion so as to not contact with the outer surface or the inner surface of the fixing belt 2 with a small space in between.

As shown in FIG. 3(a) the fixing side roller 1 or the pressing roller 5 is formed of an elastic layer 18 and a metal shaft 17. Further, as shown in FIG. 3(b), the pressing roller 5 may be formed of a releasing layer 19 disposed on the elastic layer 18. The elastic layer 18 is normally formed of a high heat resistance rubber material such as a silicone rubber, a silicone rubber with a sponge shape, a fluorine rubber, and the like. The metal shaft 17 is formed of a metal pipe or a metal shaft of aluminum, stainless steel, and the like, thereby maintaining specific rigidity.

In the embodiment, in the fixing device 11 with the configuration described above, when the fixing side roller 1 rotates in the arrow direction A, and the pressing roller 5 rotates in an arrow direction B, the fixing belt 2 moves in the arrow direction A. Accordingly, the toner 8 transferred to the recording medium 9 transported in an arrow direction C is fixed to the recording medium 9 through heat and pressure at the nip portion.

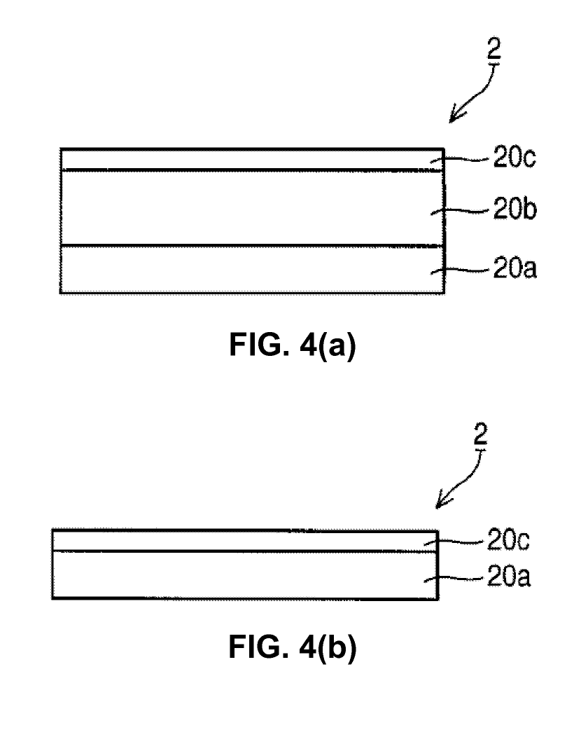

A configuration of the fixing belt 2 will be explained next with reference to FIGS. 4(a) and 4(b). FIGS. 4(a) and 4(b) are schematic sectional views showing the configuration of the fixing belt 2 of the fixing device 11 according to the first embodiment of the present invention. More specifically, FIG. 4(a) is a schematic sectional view showing one configuration the fixing belt 2 of the fixing device 11, and FIG. 4(b) is a schematic sectional view showing another configuration the fixing belt 2 of the fixing device 11.

As shown in FIG. 4(a), the fixing belt 2 is formed of a base member 20a, an elastic layer 20b disposed on the base member 20a, and a releasing layer 20c disposed on the elastic layer 20b. The base member 20a may be formed of nickel, polyimide, or stainless steel. In this case, the base member 20a preferably has a thickness between 30 μm and 150 μm for balancing strength and flexibility. The elastic layer 20b may be formed of a silicone rubber. In this case, the elastic layer 20b preferably has a thickness between 50 μm and 300 μm for balancing low hardness and high thermal conductivity. The elastic layer 20b may be formed of a fluorine resin. In this case, the elastic layer 20b preferably has a thickness between 10 μm and 50 μm for balancing low frictional wear and high thermal conductivity.

As shown in FIG. 4(b), the fixing belt 2 may be formed of the base member 20a and the releasing layer 20c disposed on the elastic layer 20b. Similar to the fixing side roller 1 and the releasing layer 19 of the pressing roller 5, the releasing layer 20c may be formed of a fluorine type resin having a high temperature resistance and a low surface free energy after molding. For example, the releasing layer 20c may be formed of a fluorine type resin such as PTFE (polytetrafluoro-ethylene), PFA (perfluoro-alkoxy-alkane), FEP (perfluoroethylene-propene coploymer), and the like. In this case, the releasing layer 20c preferably has a thickness between 10 μm and 50 μm.

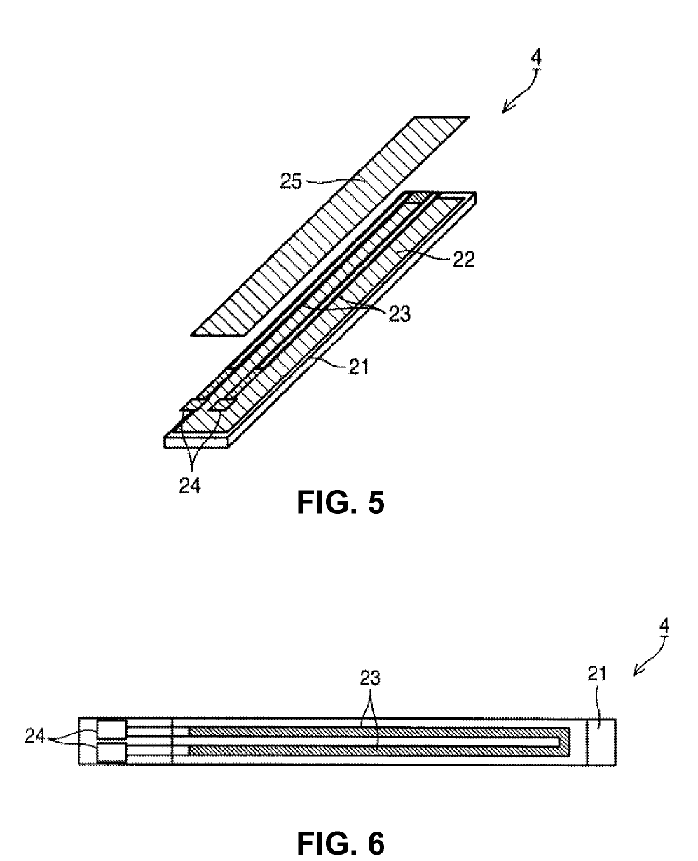

A configuration of the plate shape heating member 4 will be explained next with reference to FIGS. 5 and 6. FIG. 5 is an exploded perspective view showing the plate shape heating member 4 of the fixing device 11 according to the first embodiment of the present invention. FIG. 6 is a plan view showing the plate shape heating member 4 of the fixing device according 11 to the first embodiment of the present invention.

As shown in FIGS. 5 and 6, the plate shape heating member 4 includes a base plate 21 formed of, for example, SUS430 (stainless steel), and an electrical insulation layer 22 formed on the base plate 21 as a thin glass film. Further, a resistor heating member 23 is formed on the electrical insulation layer 22 in a paste form using powders of a nickel-chrome alloy or a silver-palladium alloy through a screen printing process. Electrodes 24 are disposed at end portions of the resistor heating member 23 using a metal with chemically stability and low electrical resistivity such as silver or a metal with a high melting point such as tungsten. Further, a protective layer 25 is formed over the resistor heating member 23 and the electrodes 24 using glass or a fluorine type resin such as PTFE, PFA, FEP, and the like. It is noted that the plate shape heating member 4 is arranged such that either of the resistor heating member 23 or the base plate 21 contacts with the inner surface of the fixing belt 2.

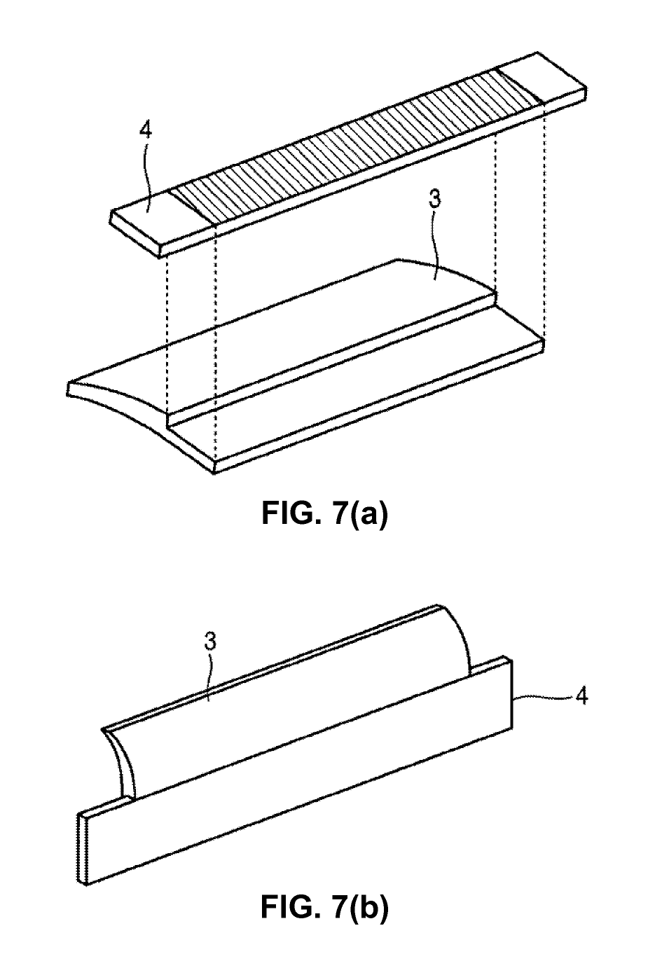

FIGS. 7(a) and 7(b) are perspective view showing the plate shape heating member 4 and the supporting member 3 of the fixing device 11 according to the first embodiment of the present invention. More specifically, FIG. 7(a) is an exploded perspective view showing the plate shape heating member 4 and the supporting member 3 in a state before being assembled, and FIG. 7(b) is a perspective view showing the plate shape heating member 4 and the supporting member 3 in a state after being assembled. It is noted that a hatched area in FIG. 7(a) represents a heating region.

In the embodiment, the supporting member 3 may be formed of a metal with high heat conductivity and easy processing ability such as aluminum, copper, and the like, an alloy thereof, steel with high heat resistance and high rigidity, an alloy thereof, or stainless steel. The supporting member 3 and the plate shape heating member 4 are arranged to integrally press against the fixing belt 2 such that the supporting member 3 and the plate shape heating member 4 as a fixing member extend the fixing belt 2 to rotate and move. Further, the plate shape heating member 4 has a flat surface or a curved surface contacting with the inner surface of the fixing belt 2, and is formed of a ceramic heater or a stainless heater.

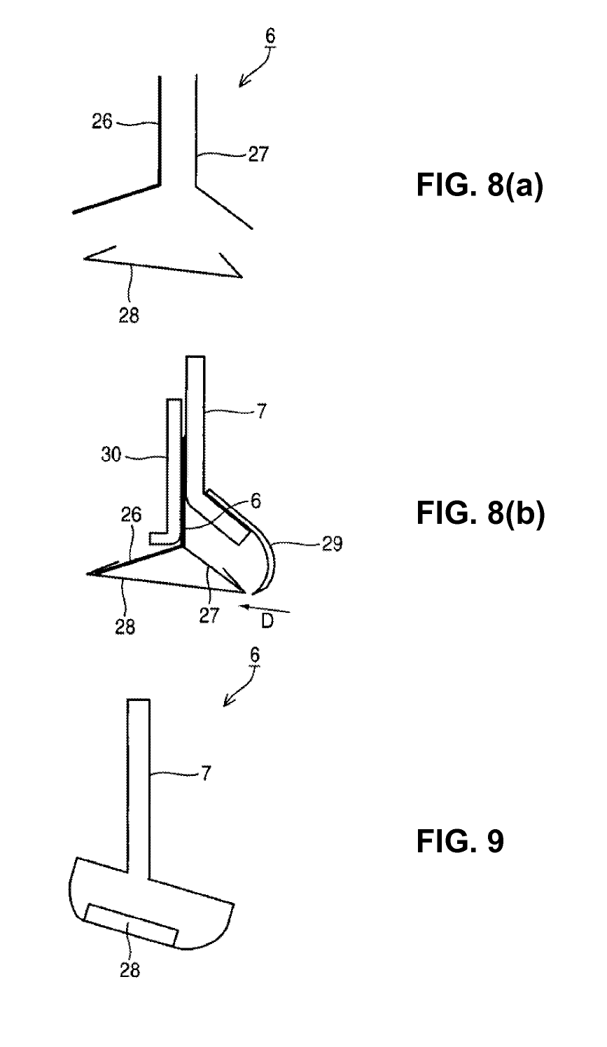

FIGS. 8(a) and 8(b) are schematic side view showing the nip forming member 6 of the fixing device 11 according to the first embodiment of the present invention. More specifically, FIG. 8(a) is a schematic side view showing the nip forming member 6 in a state before the nip forming member 6 is attached to the supporting portion 7, and FIG. 8(b) is a schematic side view showing the nip forming member 6 in a state after the nip forming member 6 is attached to the supporting portion 7.

As shown in FIG. 8(a), the nip forming member 6 includes a support member 26, a support member 27, and a contact member 28. The contact member 28 is formed of a leaf spring member for contacting with the pressing roller 5 through the fixing belt 2.

As shown in FIG. 8(b), the support member 26 and the support member 27 are tightly fitted to end portions of the contact member 28, so that the contact member 28 can slightly move in the moving direction of the fixing belt 2 and an opposite direction. Further, the support member 26 and the support member 27 are integrally fixed to the supporting portion 7 and a fixing member 30 with a screw, an adhesive, a welding, or the like.

In the embodiment, the fixing member 30 is provided for preventing the support member 26 and the support member 27 from deforming when the support member 26 and the support member 27 receive a force in a rotational direction of the fixing belt 2 or an arrow direction D in FIG. 8(b). Further, a belt guide 29 is provided for smoothly guiding the fixing belt 2 into the nip portion as shown in FIG. 1.

In the embodiment, the contact member 28 may be formed of steel, stainless steel, copper, aluminum, or an alloy thereof. A coating formed of a material with low frictional coefficient such as a fluorine type material or a silicone type material may be applied to a sliding surface of the contact member 28 relative to the fixing belt 2. Further, the contact member 28 has a thickness between 0.05 mm to 0.5 mm for effectively utilizing a spring property thereof. A length and the thickness of the contact member 28 may be determined according to a necessary load and a deformation amount. Further, the contact member 28 may be provided at a plurality of locations according to a necessary pressure distribution.

In the embodiment, the belt guide 29 may be formed of a heat resistance resin such as PPS, LCP, PEEK, and the like, so that the belt guide 29 does not absorb a large amount of heat from the fixing belt 2. Alternatively, the belt guide 29 may be formed of a metal such as steel, stainless steel, copper, aluminum, an alloy thereof, and the like, thereby preventing deformation due to heat. A coating formed of a material with low frictional coefficient such as a fluorine type material or a silicone type material may be applied to a sliding surface of the belt guide 29 relative to the fixing belt 2.

FIG. 9 is a schematic perspective view showing a modified example of the nip forming member 6 of the fixing device 11 according to the first embodiment of the present invention. As shown in FIG. 9, the nip forming member 6 may include the contact member 28 embedded in the supporting portion 7 through adhesion. In this case, the contact member 28 may be formed of an elastic member such as a silicone rubber, a fluorine rubber, and the like.

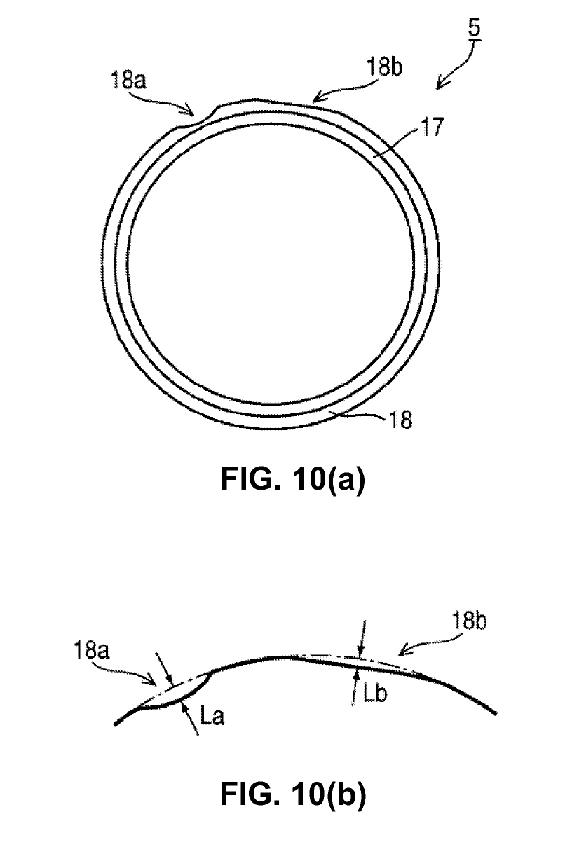

FIGS. 10(a) and 10(b) are schematic sectional views showing the pressing roller 5 of the fixing device 11 according to the first embodiment of the present invention. More specifically, FIG. 10(a) is a schematic sectional view showing the pressing roller 5 with residual strain portions 18a and 18b, and FIG. 10(b) is an enlarged schematic sectional view showing the pressing roller 5 with the residual strain portions 18a and 18b.

As shown in FIG. 10(a), the residual strain portions 18a and 18b formed in the pressing roller 5 may be observed, for example, after the pressing roller 5 of the fixing device 11 is gradually cooled down to a room temperature after the pressing roller 5 is pressed against the nip portion and maintained at 100° C. for one hour. It is noted that the releasing layer 19 shown in FIG. 3(b) is omitted in FIG. 10(a).

More specifically, as shown in FIG. 10(a), the residual strain portion 18a represents a strain portion formed in the pressing roller 5 on a side of the fixing side roller 1 where the fixing side roller 1 is pressed against the pressing roller 5. Further, the residual strain portion 18b represents a strain portion formed in the pressing roller 5 on a side of the nip forming member 6 where the nip forming member 6 is pressed against the pressing roller 5.

As shown in FIG. 10(b), the residual strain portion 18a as the strain portion formed in the pressing roller 5 on the side of the fixing side roller 1 has a residual strain amount La, and the residual strain portion 18b as the strain portion formed in the pressing roller 5 on the side of the nip forming member 6 has a residual strain amount Lb. The residual strain amounts La and Lb represent depths of the residual strain portions 18a and 18b formed in the pressing roller 5 from the outer circumferential surface of the pressing roller 5.

In the embodiment, it is configured such that the residual strain portion 18a as the strain portion formed in the pressing roller 5 on the side of the fixing side roller 1 has the residual strain amount La greater than the residual strain amount Lb of the residual strain portion 18b as the strain portion formed in the pressing roller 5 on the side of the nip forming member 6.

As shown in FIG. 1, in the fixing device 11, the pressing roller 5 is pressed against the fixing side roller 1 and the nip forming member 6. In the state that the pressing roller 5 is pressed against the nip portion, it is difficult to directly observe the residual strain portions 18a and 18b formed in the pressing roller 5. To this end, as described above, the residual strain portions 18a and 18b formed in the pressing roller 5 may be indirectly observed, for example, after the pressing roller 5 is gradually cooled down to a room temperature after the pressing roller 5 is pressed against the nip portion and maintained at 100° C. for one hour. It is noted that, the fixing side roller 1 also has a residual strain portion (not shown) after the fixing side roller 1 is gradually cooled down to a room temperature after the fixing side roller 1 is pressed against the nip portion and maintained at 160° C. for one hour.

In the embodiment, the toner 8 includes a binder resin such as polystyrene, a styrene-propylene copolymer, a styrene-vinyl naphthalene copolymer, a styrene-methyl acrylate copolymer, a polyester type copolymer, a polyurethane type copolymer, an epoxy type copolymer, an aliphatic or cycloaliphatic hydrocarbon resin, an aromatic type petroleum resin, and the like. The binder resin is composed of one type of resin or a mixture of resins. Further, the toner 8 may contain wax such as polyethylene wax, propylene wax, carnauba wax, and various ester type waxes for preventing the toner 8 from sticking to the fixing belt 2 (offset) upon fixing.

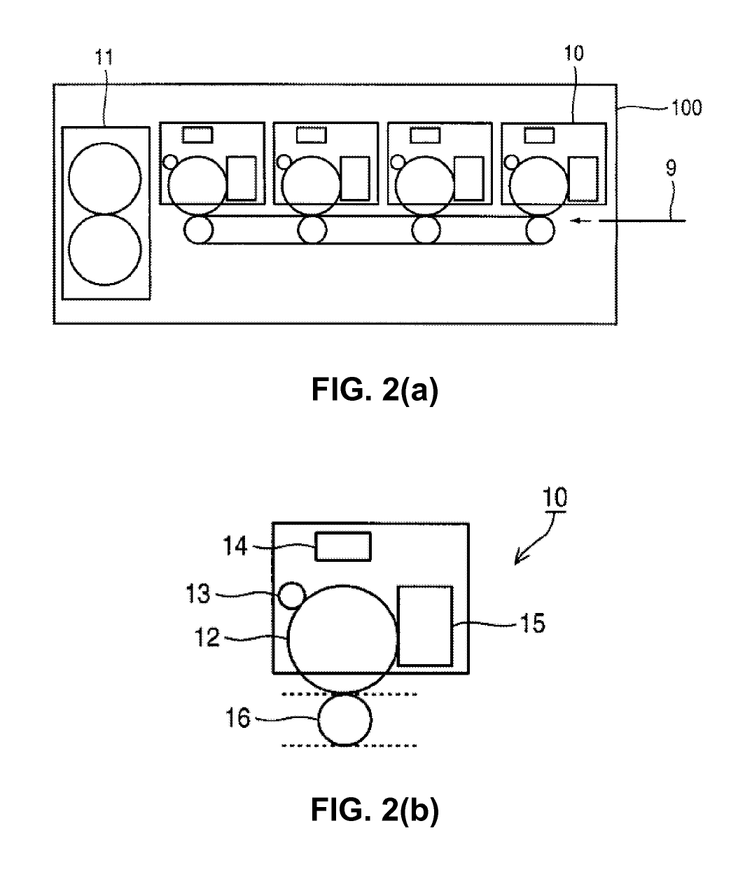

FIGS. 2(a) and 2(b) are schematic sectional views showing a configuration of an image forming apparatus 100 according to the first embodiment of the present invention. More specifically, FIG. 2(a) is a schematic sectional view showing the entire configuration of the image forming apparatus 100 having the fixing device 11, and FIG. 2(b) is an enlarged schematic sectional view showing a developing device 10 of the image forming apparatus 100.

As shown in FIG. 2(a), the image forming apparatus 100 is, for example, a copier, a printer, a facsimile, and the like, and includes the developing device 10 and the fixing device 11. As shown in FIG. 2(b), the developing device 10 includes a charging member 13 for changing an image supporting member 12 such as a photosensitive drum or a photosensitive belt. Further, the developing device 10 includes a static latent image forming member 14 for forming a static latent image on the image supporting member 12, and a developing member 15 for developing the static latent image using toner (not shown) to form a toner image. Further, the developing device 10 includes a transfer member 16 for transferring the toner image from the image supporting member 12 to the recording medium 9 as a fixed member such as a normal paper sheet or a special paper sheet. After the toner image is transferred to the recording medium 9, the recording medium 9 is transported to the fixing device 11, so that the toner image is fixed to the recording medium 9.

In the embodiment, when the image forming apparatus 100 is a color image forming apparatus such as a color copier, a color facsimile, and the like, the image forming apparatus 100 includes the developing device 10 and the transfer member 16 at four locations as shown in FIG. 2(a) for transferring toner in more than two colors to the recording medium 9. In this case, the image forming apparatus 100 includes a control device formed of a storage unit for storing a control program (software) and the like, a CPU (Central Processing Unit) as a calculation unit and a control unit, and the like, so that the control device control an operation of the image forming apparatus 100 as a whole according to the control program stored in the storage unit.

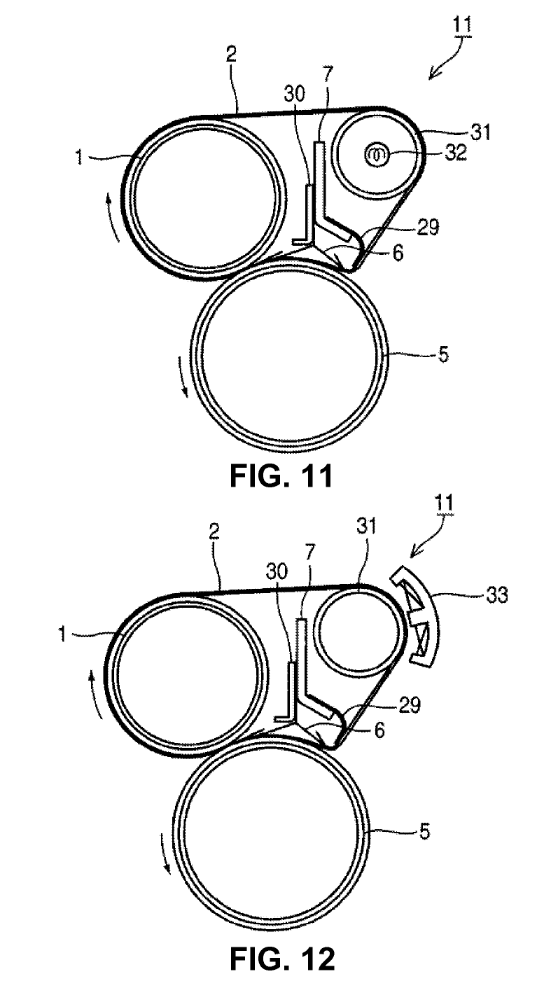

FIG. 11 is a schematic sectional view showing a modified configuration No. 1 of the fixing device 11 according to the first embodiment of the present invention. As shown in FIG. 11, instead of the plate shape heating member 4 shown in FIG. 1, the fixing device 11 may include a heating source 32 disposed in a heating roller 32.

FIG. 12 is a schematic sectional view showing a modified configuration No. 2 of the fixing device 11 according to the first embodiment of the present invention. As shown in FIG. 12, the fixing device 11 may include an electric magnetic heating member 33 disposed at a position facing the heating roller 31 with the fixing belt 2 in between. The heating roller 31 may be formed of a hollow pipe made of steel, stainless steel, cupper, and the like. The heating source 32 may be formed of a halogen lamp.

When the fixing device 11 has the configuration shown in FIG. 12, the fixing belt 2 may include the base member formed of a polyimide containing a conductive filler such as nickel, silver, copper, or aluminum.

An operation of the image forming apparatus 100 will be explained with reference to FIGS. 1, 3(a)-3(b), 4(a)-4(b), and 10(a)-10(b). First, as shown in FIG. 1, the fixing side roller 1 and the pressing roller 5 drive the fixing belt 2 to rotate in the arrow direction A while the fixing belt 2 slides against the supporting member 3, the plate shape heating member 4, and the nip forming member 6. Further, electric power is supplied to the plate shape heating member 4 to heat, so that the contact portion between the plate shape heating member 4 and the fixing belt 2 is heated. The temperature detection unit (hot shown) detects the surface temperature of the plate shape heating member 4, so that the control unit (not shown) controls the electric power supplied to the plate shape heating member 4 to maintain the surface temperature at an appropriate level.

As described above, the pressing roller 5 is pressed against the fixing side roller 1 and the nip forming member 6 with the fixing belt 2 in between to form the nip portion. After the toner 8 is transferred to the recording medium 9, the recording medium 9 is transported through the nip portion between the fixing belt 2 and the pressing roller 5, so that the toner 8 is fixed to the recording medium 9 through heating and pressing with the fixing belt 2 and the pressing roller 5. In the embodiment, the fixing side roller 1 is arranged to rotate at a circumferential speed greater than that of the pressing roller 5. Accordingly, the pressing roller 5 is configured to rotate while the pressing roller 5 is repeatedly slipping to a subtle extent with respect to the fixing belt 2 and the recording medium 9.

As shown in FIG. 10, when the pressing roller 5 is pressed against the nip portion and maintained at 100° C. for one hour, the pressing roller 5 is greatly deformed due to creep as compared with the situation when the fixing device 11 is operated. The deformation tends to be restored after being cooled down. It is found that a shaft distance between the fixing side roller 1 and the pressing roller 5 when the fixing device 11 is operated is substantially equal to a value obtained by subtracting the residual strain amount from the shaft distance when no load is applied. Accordingly, it may be supposed that the residual strain amount of the pressing roller 5 is substantially equal to the residual strain amount thereof when the fixing device 11 is operated. Similarly, it may be supposed that the residual strain amount of the fixing side roller 1 after the fixing side roller 1 is pressed against the nip portion and maintained at 160° C. for one hour is substantially equal to the residual strain amount thereof when the fixing device 11 is operated.

In the embodiment, as described above, it is configured such that when the pressing roller 5 is deformed, the residual strain portion 18a as the strain portion formed in the pressing roller 5 on the side of the fixing side roller 1 has the residual strain amount La greater than the residual strain amount Lb of the residual strain portion 18b as the strain portion formed in the pressing roller 5 on the side of the nip forming member 6.

In the embodiment, as shown in FIG. 1, the recording medium 9 enters from the side of the nip forming member 6. Accordingly, if the residual strain amount Lb of the residual strain portion 18b on the side of the nip forming member 6 is greater than the residual strain amount La of the residual strain portion 18a on the side of the fixing side roller 1, the recording medium 9 tends to become winkled. Further, in the fixing device 11, it is configured such that the recording medium 9 is transported through the nip portion over a long distance with the fixing side roller 1 and the nip forming member 6. Accordingly, the nip portion has an upward convex shape. As a result, the recording medium 9 tends to approach the pressing roller 5 near an outside of an exit of the nip portion, so that the recording medium 9 is easily wound around the pressing roller 5.

To this end, in the embodiment, it is configured such that the pressing roller 5 is deformed greatly with the fixing side roller 1. Accordingly, the recording medium 9 tends to be away from the pressing roller 5 near the outside of the exit of the nip portion, so that it is possible to prevent the recording medium 9 from being easily wound around the pressing roller 5.

However, when the pressing roller 5 is deformed greatly with the fixing side roller 1 as described above, and only the pressing roller 5 is rotated, an image shift may occur on the recording medium 9. When the pressing roller 5 is deformed less on the side of the fixing side roller 1 than the side of the nip forming member 6, the circumferential speed of the pressing roller 5 on the side of the fixing side roller 1 becomes smaller than the side of the nip forming member 6. As a result, the fixing belt 2 may become slack at a portion between the nip forming member 6 and the fixing side roller 1 where pressure is not sufficiently applied (referred to as an insufficient pressure portion). When the pressing roller 5 is stopped in the middle of passing the recording medium 9 through the fixing device 11, it is found that the image shift occurs on the recording medium 9 at the insufficient pressure portion of the fixing belt 2.

In the situation described above, it is supposed that when the fixing belt 2 repeatedly slips to a subtle extent with respect to the pressing roller 5 without causing a slack in the fixing belt 2, the image shift occurs on the recording medium 9. If this assumption is true, to prevent the image shift, it is necessary to arrange the fixing belt 2 so as to not cause a slack at the insufficient pressure portion between the fixing side roller 1 and the nip forming member 6.

In order to prevent the fixing belt 2 from causing the slack, an experiments No. 1 and No. 2 were conducted. In the experiments No. 1 and No. 2, the fixing device 11 was configured such that the circumferential speed of the fixing side roller 1 was set to become greater than the circumferential speed of the pressing roller 5.

More specifically, in the experiment No. 1, a gear ratio of the fixing side roller 1 and the pressing roller 5 was adjusted such that the circumferential speed of the fixing side roller 1 became greater than the circumferential speed of the pressing roller 5.

In the experiment No. 1, the fixing belt 2 had an inner diameter of 45 mm. The base member 20a was formed of a polyimide and had a thickness of 80 μm. The elastic layer 20b was formed of a silicone rubber and had a thickness of 150 μm. The releasing layer 20c was formed of PFA and had a thickness of 30 μm. The fixing side roller 1 had a diameter of 24.0 mm. The elastic layer 18 was formed of a silicone sponge, and had a thickness of 1. 0 mm and an ASKER C hardness of 78 degrees (measured with an ASKER-C hardness meter, a product of KOBUNSHI KEIKI Co., Ltd.). The fixing side roller 1 was pressed with the pressing force of 10 kg·f, and had a gear teeth number of 24. The fixing side roller 1 had an outer diameter of 24.2 mm at 160° C. The nip portion between the fixing side roller 1 and the pressing roller 5 had the residual strain amount of 0.2 mm. The leaf spring member (the contact member 28 of the nip forming member 6) was formed of SUS304, and had a plate thickness of 0.5 mm. The leaf spring member was pressed with the pressing force of 10 kg·f.

Further, in the experiment No. 1, the pressing roller 5 had a diameter of 36 mm. The elastic layer 18 was formed of a silicone rubber, and had a thickness of 1.50 mm and the ASKER C hardness of 75 degrees. The releasing layer 19 was formed of PFA and had a thickness of 30 μm. The pressing roller 5 had a gear teeth number of 37, and an outer diameter of 36.2 mm at 100° C. The pressing roller 5 had the residual strain amount of 0.2 mm on the side of the fixing side roller 1, and the residual strain amount of 0.0 mm on the side of the nip forming member 6 (the residual strain amount on the side of the nip forming member 6 was minute and represented as 0.0 mm).

Further, in the experiment No. 1, the plate shape heating member 4 was formed of a stainless heater, and had a width of 12 mm (a length in the moving direction of the fixing belt 2) and an power output of 850 W. The plate shape heating member 4 is pressed against the fixing belt 2 with the pressing force of 1.0 kg·f. The toner 8 was formed of polystyrene toner (yellow, magenta, and cyan), and contained 15 weight parts of wax. The recording medium 9 had a density of 64 g/m², and a size of A4. The recording medium 9 was transported in a vertical direction thereof. A transfer amount of the toner 8 was 1.5±0.1 g/sheet. The recording medium 9 was transported at a passing sheet speed of 240 mm/s. A total nip width (the length of the nip portion from the entrance to the exit in the moving direction of the fixing belt 2) was 18 mm.

In the experiment No. 1, the surface temperature of the fixing belt 2 was measured at the exit of the nip portion with the temperature detection unit (not shown), and the control unit (not shown) controlled so that the surface temperature was maintained at 160° C. The gears for driving each roller were connected through a common idle gear. The pressing roller 5 had the outer diameter greater than that of the fixing side roller 1. Further, the fixing side roller 1 had the shaft metal made of steel, while the pressing roller 5 had the shaft metal made of aluminum that has a thermal expansion coefficient greater than that of steel. As a result, the fixing side roller 1 had a thermal expansion coefficient substantially equal to that of the pressing roller 5.

Under the conditions described above, when the circumferential speed of the fixing side roller 1 was 240 mm/s, the circumferential speed of the pressing roller 5 was obtained from the teeth number of the gear through the following calculation:

36 mm (the diameter of the pressing roller 5)/37 (the gear teeth number)×240 =233.51 mm/s

Accordingly, the circumferential speed of the pressing roller 5 was slower than the circumferential speed of the fixing side roller 1 was by about 6.5 mm/s. When both the fixing side roller 1 and the pressing roller 5 were driven under the conditions described above, the color shift did not occur. The transportation speed of the recording medium 9 was measured to be about 238 mm/s.

In the experiment No. 1, the circumferential speed of the fixing side roller 1 at the nip portion was calculated through the following calculation:

240 mm/s×(24.2 mm (the outer diameter of the fixing side roller 1)−0.2 mm (the residual strain amount of the fixing side roller 1)/24.2 mm (the outer diameter of the fixing side roller 1)=238.0166 mm/s

Accordingly, the circumferential speed of the fixing side roller 1 was very close to the transportation speed of the recording medium 9. Therefore, it is supposed that the difference between the circumferential speed of the fixing side roller 1 and the circumferential speed of the pressing roller 5 was absorbed by a slight slippage between the fixing belt 2 and the pressing roller 5, and the recording medium 9 and the pressing roller 5.

An experiment No. 2 was also conducted under conditions explained below. In the experiment No. 2, the strain amount of the strain portion formed in the pressing roller 5 by the fixing side roller 1 and the strain amount of the strain portion formed in the fixing side roller 1 by the pressing roller 5 were changed. Due to the difference in the outer diameters of the fixing side roller 1 and the pressing roller 5, the circumferential speed of the fixing side roller 1 was configured to become greater than the circumferential speed of the pressing roller 5.

In the experiment No. 2, the fixing belt 2 had the inner diameter of 45 mm. The base member 20a was formed of a polyimide and had the thickness of 80 μm. The elastic layer 20b was formed of a silicone rubber and had the thickness of 150 μm. The releasing layer 20c was formed of PFA and had the thickness of 30 μm. The fixing side roller 1 had the diameter of 24.2 mm. The elastic layer 18 was formed of a silicone sponge, and had the thickness of 1.0 mm and the ASKER C hardness of 78 degrees. The fixing side roller 1 was pressed with the pressing force of 10 kg·f, and had the gear teeth number of 24. The fixing side roller 1 had the outer diameter of 24.4 mm at 160° C. The nip portion between the fixing side roller 1 and the pressing roller 5 had the residual strain amount of 0.2 mm. The leaf spring member (the contact member 28 of the nip forming member 6) was formed of SUS304, and had the plate thickness of 0.5 mm. The leaf spring member was pressed with the pressing force of 10 kg·f.

Further, in the experiment No. 2, the pressing roller 5 had the diameter of 36 mm. The elastic layer 18 was formed of a silicone rubber, and had the thickness of 1.50 mm and the ASKER C hardness of 75 degrees. The releasing layer 19 was formed of PFA and had the thickness of 30 μm. The pressing roller 5 had the gear teeth number of 36, and the outer diameter of 36.2 mm at 100° C. The pressing roller 5 had the residual strain amount of 0.2 mm on the side of the fixing side roller 1, and the residual strain amount of 0.0 mm on the side of the nip forming member 6 (the residual strain amount on the side of the nip forming member 6 was minute and represented as 0.0 mm).

Further, in the experiment No. 2, the plate shape heating member 4 was formed of the stainless heater, and had the width of 12 mm (the length in the moving direction of the fixing belt 2) and the power output of 850 W. The plate shape heating member 4 is pressed against the fixing belt 2 with the pressing force of 1.0 kg·f. The toner 8 was formed of polystyrene toner (yellow, magenta, and cyan), and contained 15 weight parts of wax. The recording medium 9 had the density of 64 g/m², and the size of A4. The recording medium 9 was transported in the vertical direction thereof. The transfer amount of the toner 8 was 1.5±0.1 g/sheet. The recording medium 9 was transported at the passing sheet speed of 240 mm/s. The total nip width (the length of the nip portion from the entrance to the exit in the moving direction of the fixing belt 2) was 18 mm.

Similar to the experiment No. 1, in the experiment No. 2, the surface temperature of the fixing belt 2 was measured at the exit of the nip portion with the temperature detection unit (not shown), and the control unit (not shown) controlled so that the surface temperature was maintained at 160° C. The gears for driving each roller were connected through the common idle gear.

In the experiment No. 2, the pressing roller 5 had the outer diameter greater than that of the fixing side roller 1. Further, the fixing side roller 1 had the shaft metal made of steel, while the pressing roller 5 had the shaft metal made of aluminum that has a thermal expansion coefficient greater than that of steel. As a result, the fixing side roller 1 had a thermal expansion coefficient substantially equal to that of the pressing roller 5. Further, the rotation of the fixing side roller 1 was adjusted such that the pass sheet speed (the circumferential speed of the fixing side roller 1 at the nip portion) became 240 mm/s.

In the experiment No. 2, a rotational radius of the pressing roller 5 at the nip portion on the side of the fixing side roller 1 was smaller than that at the nip portion on the side of the nip forming member 6 due to the residual strain portion. Accordingly, the circumferential speed of the pressing roller 5 at the nip portion on the side of the fixing side roller 1 was smaller than that at the nip portion on the side of the nip forming member 6 by about 0.8% through the following calculation:

(1−(36.2 mm (the outer diameter at 100° C.)−0.3 mm (the residual strain amount)/36.2 mm (the outer diameter at 100° C.))×100%=0.828%

Further, the circumferential speed of the fixing side roller 1 at the nip portion was greater than that of the pressing roller 5 at the nip portion on the side of the fixing side roller 1 by about 1.1% through the following calculation:

(((24.4 mm (the outer diameter of the fixing side roller 1 at 160° C.)−0.2 mm (the residual strain amount))/(24 (the gear teeth number of the fixing side roller 1))−1) +(1−36.2 mm (the outer diameter of the pressing roller 5 at 100° C.)−0.3 mm (the residual strain amount))/36 (the gear teeth number of the pressing roller 5)))×100%=1.111%

In the experiment No. 2, the circumferential speed of the fixing side roller 1 at the nip portion was greater than the circumferential speed of the pressing roller 5 at the nip portion on the side of the nip forming member 6 by about 0.3% (1.1115−0.828%=0.283%). Accordingly, the circumferential speed of the pressing roller 5 at the nip portion on the side of the fixing side roller 1 was calculated as follows:

240×(100−1.111)/100=237.338 mm/s

Under the conditions described above, when both the fixing side roller 1 and the pressing roller 5 were driven, the color shift did not occur. The transportation speed of the recording medium 9 was measured to be about 238 mm/s. Accordingly, the transportation speed of the recording medium 9 matched the circumferential speed of the fixing side roller 1 at the nip portion. Therefore, it is supposed that the difference between the circumferential speed of the fixing side roller 1 and the circumferential speed of the pressing roller 5 was absorbed by a slight slippage between the fixing belt 2 and the pressing roller 5, and the recording medium 9 and the pressing roller 5.

Further, when only the fixing side roller 1 was driven, the color shift did not occur. As described above, the fixing side roller 1 was formed of the sponge roller. The sponge roller tends to be susceptible to a shear stress upon being driven. Accordingly, when only the fixing side roller 1 is driven, the life of the fixing device 11 tends to be shortened. Therefore, it is not preferable to drive only the fixing side roller 1.

A relationship between the residual strain amount of the pressing roller 5 on the side of the fixing side roller 1 and the color shift in the experiment No. 2 is summarized in Table 1. It is noted that in Table 1, “good” represents a result of no color shift, and “poor” represents the color shift occurred.

TABLE 1

| | Residual strain amount (mm) | | | | | | |
|---|---|---|---|---|---|---|---|
| | 0.02 | 0.04 | 0.05 | 0.08 | 0.12 | 0.19 | 0.3 |
| Color shift | good | good | good | good | good | good | good |

As shown in Table 1, when the residual strain amount of the pressing roller 5 on the side of the fixing side roller 1 was between 0.02 and 0.3 mm, the color shift did not occur. At a first glance, it is considered that there is a continuous relationship between the residual strain amount of the pressing roller 5 on the side of the fixing side roller 1 and the color shift. When the fixing belt 2 had a slight slack between the fixing side roller 1 and the nip forming member 6, a restoration force of the fixing belt 2 to slip was weak even when only the pressing roller 5 was driven. Accordingly, it is supposed that the color shift was not visible (observable), so that the color shift did not occur in the experiment No. 2 (Table 1).

Then, only the pressing roller 5 was driven to rotate the fixing side roller 1 and the fixing belt 2, and a relationship between the residual strain amount of the pressing roller 5 on the side of the fixing side roller 1 and the color shift was evaluated. The relationship is summarized in Table 2. It is noted that in Table 2, “good” represents a result of no color shift, and “poor” represents the color shift occurred.

TABLE 2

| | Residual strain amount (mm) | | | | | | |
|---|---|---|---|---|---|---|---|
| | 0.02 | 0.04 | 0.05 | 0.08 | 0.12 | 0.19 | 0.3 |
| Color shift | good | good | poor | poor | poor | poor | poor |

As shown in Table 2, when the residual strain amount of the pressing roller 5 on the side of the fixing side roller 1 was equal to or smaller than 0.04 mm, the color shift did not occur, and when the residual strain amount of the pressing roller 5 on the side of the fixing side roller 1 was greater than 0.04 mm, the color shift did occur. In principle, it is considered that the slack of the fixing belt 2 can be small but does not become zero, and the color shift should occur. In reality, however, the color shift did not occur when the residual strain amount of the pressing roller 5 on the side of the fixing side roller 1 was smaller than 0.04 mm. Accordingly, in this case, it is supposed that the fixing belt 2 did not repeat a minute slippage, but slipped continuously, so that a small color shift that is not visible (observable) did occur.

As explained above, in the case that only the pressing roller 5 is driven to rotate the fixing side roller 1 and the fixing belt 2, it is possible to prevent the color shift through adjusting the residual strain amount of the pressing roller 5 on the side of the fixing side roller 1 smaller than 0.04 mm.

As explained above, in the embodiment, it is configured such that the residual strain amount La as the depth of the residual strain portion 18a formed as the strain portion in the pressing roller 5 by the fixing side roller 1 becomes greater than the residual strain amount Lb of the residual strain portion 18b formed as the strain portion in the pressing roller 5 by the nip forming member 6. Further, it is configured such that the circumferential speed of the fixing side roller 1 becomes greater than the circumferential speed of the pressing roller 5. Accordingly, the slack of the fixing belt 2 is no created at the insufficient pressure portion between the nip forming member 6 and the fixing side roller 1, and it is possible to prevent the color shift.

Further, in the case that only the pressing roller 5 is driven to rotate the fixing side roller 1 and the fixing belt 2, it is possible to prevent the color shift through adjusting the residual strain amount of the pressing roller 5 on the side of the fixing side roller 1 smaller than 0.04 mm. It is noted that, when the residual strain amount of the pressing roller 5 on the side of the fixing side roller 1 is set to be greater than 0.05 mm, it is possible to prevent the color shift through driving both the pressing roller 5 and the fixing side roller 1.

As described above, in the embodiment, it is configured such that the residual strain amount La as the depth of the residual strain portion 18a formed as the strain portion in the pressing roller 5 by the fixing side roller 1 becomes greater than the residual strain amount Lb of the residual strain portion 18b formed as the strain portion in the pressing roller 5 by the nip forming member 6. Further, it is configured such that the circumferential speed of the fixing side roller 1 becomes greater than the circumferential speed of the pressing roller 5. Accordingly, the slack of the fixing belt 2 is no created at the insufficient pressure portion between the nip forming member 6 and the fixing side roller 1, and it is possible to prevent the color shift.

Further, in the case that only the pressing roller 5 is driven to rotate the fixing side roller 1 and the fixing belt 2, it is possible to prevent the color shift through adjusting the residual strain amount of the pressing roller 5 on the side of the fixing side roller 1 smaller than 0.04 mm.

### Second Embodiment

A second embodiment of the present invention will be explained next. A configuration of the fixing device 11 and the image forming apparatus 100 in the second embodiment is similar to that in the first embodiment. Accordingly, components in the second embodiment are designated with the same reference numerals, and explanations thereof are omitted.

In the second embodiment, the outer diameter of the fixing side roller 1 shown in FIG. 1 is changed in a range of 18 mm and 30 mm by an increment of 2 mm, so that a relationship between the outer diameter of the fixing side roller 1 and the color shift is evaluated in the case that only the pressing roller 5 is driven.

As described above, the pressing roller 5 has the outer diameter greater than that of the fixing side roller 1, so that the pressing roller 5 is pressed against the fixing side roller 1 and the nip forming member 6. In other words, the fixing side roller 1 has the outer diameter smaller than that of the pressing roller 5. Accordingly, when the circumferential speed of the fixing side roller 1 is increased, a life of the surface of the fixing device 11 tends to be shortened due to the rotation. To this end, in the fixing device 11 in the second embodiment, the pressing roller 5 is driven to move the fixing belt 2.

An effect of the fixing device 11 and the image forming apparatus 100 with the configuration described above will be explained next with reference to FIG. 1. It is noted that an operation of the fixing device 11 is similar to that in the first embodiment, and an explanation thereof is omitted.

An experiment No. 3 was conducted for evaluating a relationship of the color shift with respect to the strain amount of the strain portion formed in the pressing roller 5 on the side of the fixing side roller 1 and the outer diameter of the fixing side roller 1 in the case that only the pressing roller 5 was driven to rotate the fixing side roller 1 and the fixing belt 2.

In the experiment No. 3, the outer diameter of the fixing side roller 1 was changed in a range of 18 mm and 30 mm by an increment of 2 mm, and the strain amount of the strain portion formed in the pressing roller 5 on the side of the fixing side roller 1 was changed in a range of 0.02 mm and 0.26 mm. Other conditions were similar to those in the experiment No. 2.

A result of the experiment No. 3 is shown in Table 3. It is noted that in Table 3, “good” represents a result of no color shift, and “poor” represents the color shift occurred.

TABLE 3

| Outer | | | | | |
|---|---|---|---|---|---|
| diameter | Residual strain amount (mm) | | | | |
| (mm) | 0.02 | 0.04 | 0.05 | 0.12 | 0.26 |
| 18 | good | good | poor | poor | poor |
| 20 | good | good | poor | poor | poor |
| 22 | good | good | poor | poor | poor |
| 24 | good | good | poor | poor | poor |
| 26 | good | good | poor | poor | poor |
| 28 | poor | poor | poor | poor | poor |
| 30 | poor | poor | poor | poor | poor |

As shown in Table 3, it is possible to prevent the color shift through adjusting the strain amount of the pressing roller 5 to be equal to or smaller than 0.04 mm, and the outer diameter of the fixing side roller 1 to be equal to or smaller than 26 mm. In the experiment No. 2 in the first embodiment, the outer diameter of the fixing side roller 1 is set to be 24.2 mm. The outer diameter of the fixing side roller 1 is not limited thereto, and can be set to be equal to or smaller than 26 mm. It is noted that, even when the strain amount of the pressing roller 5 is equal to or smaller than 0.04 mm, the color shift still occurs if the outer diameter of the fixing side roller 1 is not equal to or smaller than 26 mm. Further, when the strain amount of the pressing roller 5 is greater than 0.04 mm, the color shift occurs regardless of the outer diameter of the fixing side roller 1.

Accordingly, even in the case that only the pressing roller 5 is driven to rotate the fixing side roller 1 and the fixing belt 2, it is possible to prevent the color shift by adjusting the strain amount of the pressing roller 5 to be equal to or smaller than 0.04 mm, and the outer diameter of the fixing side roller 1 to be equal to or smaller than 26 mm. It is noted that it is necessary to deform the pressing roller 5 with the fixing side roller 1 to some extent to prevent the pressing roller 5 from winding around the pressing roller 5.

As described above, in the second embodiment, even in the case that only the pressing roller 5 is driven to rotate the fixing side roller 1 and the fixing belt 2, it is possible to prevent the color shift by adjusting the strain amount of the pressing roller 5 to be equal to or smaller than 0.04 mm, and the outer diameter of the fixing side roller 1 to be equal to or smaller than 26 mm.

It is noted that the present invention is applicable to an image forming apparatus such as a copier, a printer, a facsimile, and the like capable of forming a monochrome image or a color image in more than two colors.

The disclosure of Japanese Patent Application No. 2010-231654, filed on Oct. 14, 2010, is incorporated in the application.

While the invention has been explained with reference to the specific embodiments of the invention, the explanation is illustrative and the invention is limited only by the appended claims.

What is claimed is:

1. A fixing device comprising:
a fixing belt with an endless shape to be heated with a heating member;
a pressing roller disposed outside the fixing belt;
a fixing side roller disposed inside the fixing belt and pressed against the pressing roller with the fixing belt in between; and
a nip forming member disposed inside the fixing belt and pressed against the pressing roller with the fixing belt in between,
wherein said fixing side roller is arranged to form a first strain portion having a first strain amount in the pressing roller and said nip forming member is arranged to form a second strain portion having a second strain amount in the pressing roller so that the first strain amount is greater than the second strain amount.

2. The fixing device according to claim 1, wherein said fixing side roller is arranged to rotate at a circumferential speed greater than that of the pressing roller.

3. The fixing device according to claim 1, wherein said fixing belt is arranged to move when the fixing side roller rotates, said fixing side roller being disposed on a downstream side of the nip forming member in a direction that the fixing belt moves.

4. The fixing device according to claim 1, wherein said fixing side roller is arranged to rotate at a circumferential speed greater than that of the pressing roller through a specific gear ratio between the fixing side roller and the pressing roller.

5. The fixing device according to claim 1, wherein said fixing side roller is arranged to rotate at a circumferential speed greater than that of the pressing roller through adjusting the first strain amount and the second strain amount.

6. The fixing device according to claim 1, wherein said fixing side roller is arranged to form the first strain portion having the first strain amount equal to or smaller than 0.04 mm.

7. The fixing device according to claim 1, wherein said fixing side roller has an outer diameter equal to or smaller than 26 mm.

8. The fixing device according to claim 1, wherein said pressing roller is arranged to be driven to rotate the fixing side roller and the fixing belt.

9. The fixing device according to claim 1, wherein said pressing roller and said fixing side roller are arranged to be driven to rotate the fixing belt, said fixing side roller being arranged to form the first strain portion having the first strain amount equal to or smaller than 0.05 mm.

10. An image forming apparatus comprising the fixing device according to claim 1.
